(19) United States
(12) Patent Application Publication
(10) Pub. No.: US 2004/0183335 A1
(43) Pub. Date: Sep. 23, 2004

(54) Unibody box structure for holding bulk material

(76) Inventors: Dennis A. Beam III, Shelby, NC (US); Daniel Tremblay, Gatineau (CA)

Correspondence Address: Christopher L. Bernard, Christopher L. Bernard, PLLC, 511 West 8th Street #2B, Charlotte, NC, 28202, US

(21) Appl. No.: 10/394,520

(22) Filed: Mar. 21, 2003

(51) Int. Cl. B62D 33/02

(52) U.S. Cl. 296/187.01

(57) ABSTRACT

A box structure for holding bulk material, and an associated method of manufacture, including a bottom member having an inside surface and an outside surface, wherein the bottom member is formed from a substantially-rigid material. The box structure also including a plurality of channel structures in direct contact with and fixedly attached to the outside surface of the bottom member, wherein each of the plurality of channel structures is formed from a substantially-rigid material, and wherein the plurality of channel structures are configured to receive an attachment mechanism for movably and/or removably attaching the box structure to a vehicle. The box structure further including a plurality of side members each having an inside surface and an outside surface, the plurality of side members collectively defining an opening, wherein each of the plurality of side members is formed from a substantially-rigid material. The box structure still further including a top member having an inside surface and an outside surface, wherein the top member is formed from a substantially-rigid material.

### FIELD OF THE INVENTION

The present invention relates generally to a unibody box structure for holding bulk material. More specifically, the present invention relates to a unibody box structure for holding bulk material that may be movably and/or removably attached to a vehicle.

### BACKGROUND OF THE INVENTION

Conventional box structures for holding bulk material, such as those attached to dump-trucks or the like, typically include a metal box built on a frame structure. This frame structure is fixedly attached to a plurality of beams which are configured to receive an attachment mechanism for movably and/or removably attaching the box structure to the vehicle. The frame structure, and not the metal box, represents the core structural element of the system as a whole.

One disadvantage of this setup is that the frame structure introduces manufacturing complexity into the system. The frame structure typically consists of a plurality of members that must be aligned and welded together. Another disadvantage of this setup is that the presence of the frame structure increases the overall height of the system, thus increasing the height of its center of gravity. For example, the frame structure may increase the overall height of the system by as much as 2 to 6 inches. Because a vehicle is involved, this introduces safety concerns.

In addition to the problems described above, conventional box structures for holding bulk material are typically made of a mild steel that has a corrosion-resistant coating. For example, galvanneal steel is typically used. Galvanneal steel is produced on a continuous hot-dipped galvanized steel line. As the steel emerges from a molten zinc bath, excess zinc is removed from the surface of the steel using heated air knives. An annealing furnace is then used to convert the zinc into a corrosion-resistant zinc-iron alloy coating. In order to prepare the coating for finishing, the surface must be prepared with a solvent to remove foreign substances and contaminates. One disadvantage of the use of such materials is that, if the corrosion-resistant coating is scratched or otherwise damaged (or if it is defective), the steel underneath is exposed to the elements and subject to corrosion.

Thus, what is needed is a box structure for holding bulk materials that has a unibody construction, widely used in the automotive and other industries. This unibody construction would eliminate the need for a complex frame structure, thereby streamlining the manufacturing process of the box structure and reducing the overall height and center of gravity of the system. What is also needed is a box structure that is made of a high-strength material that is corrosion-resistant throughout.

### BRIEF SUMMARY OF THE INVENTION

The present invention provides a unibody box structure for holding bulk material, such as wood chips and the like. This unibody box structure incorporates a metal box and a plurality of channel structures which are welded to or integrally formed with the metal box. These channel structures are configured to receive an attachment mechanism for movably and/or removably attaching the unibody box structure to a vehicle, such as a truck or the like. Advantageously, the metal box acts as the core structural element of the system as a whole, thus eliminating the frame structure described above and reducing the overall height and center of gravity of the system. Optionally, the unibody box structure is made of a high-strength, corrosion-resistant material and may be powder coated, partially or wholly with an anti-slip finish. The unibody box structure of the present invention provides a functional, aesthetically-pleasing structure, with minimal area for debris collection.

In one embodiment of the present invention, a box structure for holding bulk material includes a bottom member having an inside surface and an outside surface, wherein the bottom member is formed from a substantially-rigid material. The box structure also includes a plurality of channel structures in direct contact with and fixedly attached to the outside surface of the bottom member, wherein each of the plurality of channel structures is formed from a substantially-rigid material.

In another embodiment of the present invention, a box structure for holding bulk material includes a bottom member having an inside surface and an outside surface, wherein the bottom member is formed from a substantially-rigid material. The box structure also includes a plurality of channel structures in direct contact with and fixedly attached to the outside surface of the bottom member, wherein each of the plurality of channel structures is formed from a substantially-rigid material, and wherein the plurality of channel structures are configured to receive an attachment mechanism for movably and/or removably attaching the box structure to a vehicle. The box structure further includes a plurality of side members each having an inside surface and an outside surface, the plurality of side members collectively defining an opening, wherein each of the plurality of side members is formed from a substantially-rigid material. The box structure still further includes a top member having an inside surface and an outside surface, wherein the top member is formed from a substantially-rigid material.

In a further embodiment of the present invention, a method for manufacturing a box structure for holding bulk material includes providing a bottom member having an inside surface and an outside surface, wherein the bottom member is formed from a substantially-rigid material. The method also includes placing a plurality of channel structures in direct contact with and fixedly attaching the plurality of channel structures to the outside surface of the bottom member, wherein each of the plurality of channel structures is formed from a substantially-rigid material, and wherein the plurality of channel structures are configured to receive an attachment mechanism for movably and/or removably attaching the box structure to a vehicle. The method further includes providing a plurality of side members each having an inside surface and an outside surface, the plurality of side members collectively defining an opening, wherein each of the plurality of side members is formed from a substantially-rigid material. The method still further includes providing a top member having an inside surface and an outside surface, wherein the top member is formed from a substantially-rigid material.

In a still further embodiment of the present invention, a box structure for holding bulk material includes a bottom member having an inside surface and an outside surface, wherein the bottom member is formed from a high-strength, corrosion-resistant material. The box structure also includes a plurality of side members each having an inside surface and an outside surface, the plurality of side members collectively defining an opening, wherein each of the plurality of side members is formed from a high-strength, corrosion-resistant material. Optionally, the box structure further includes a top member having an inside surface and an outside surface, wherein the top member is formed from a high-strength, corrosion-resistant material. For example, the bottom member, the plurality of side members and the top member may be formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

In a still further embodiment of the present invention, a box structure for holding bulk material includes a bottom member having an inside surface and an outside surface, wherein the bottom member is formed from a substantially-rigid material. The box structure also includes a plurality of side members each having an inside surface and an outside surface, the plurality of side members collectively defining an opening, wherein each of the plurality of side members is formed from a substantially-rigid material. The box structure further includes a powder coating disposed on the inside surfaces and the outside surfaces of the bottom member and the plurality of side members. Optionally, the box structure still further includes a top member having an inside surface and an outside surface, wherein the top member is formed from a substantially-rigid material. A powder coating may also be disposed on the inside surface and the outside surface of the top member. A portion of the powder coating disposed on the inside surface of the bottom member may include an abrasive material.

### BRIEF DESCRIPTION OF THE DRAWINGS

FIG. 1 is a side plan view of a conventional framed box structure for holding bulk material, the conventional framed box structure movably attached to a vehicle;

FIG. 2 is a bottom plan view of the frame structure associated with the conventional framed box structure of FIG. 1;

FIG. 3 is a front plan view of the conventional framed box structure of FIG. 1;

FIG. 4 is a side plan view of one embodiment of the unibody box structure for holding bulk material of the present invention, the unibody box structure movably attached to a vehicle;

FIG. 5 is a perspective view of the unibody box structure of FIG. 4;

FIG. 6 is a bottom plan view of the unibody box structure of FIG. 4;

FIG. 7 is a front plan view of the unibody box structure of FIG. 4;

FIG. 8 is a rear plan view of the unibody box structure of FIG. 4; and

FIG. 9 is a perspective view of one embodiment of a channel structure associated with the unibody box structure of FIG. 4.

### DETAILED DESCRIPTION OF THE INVENTION

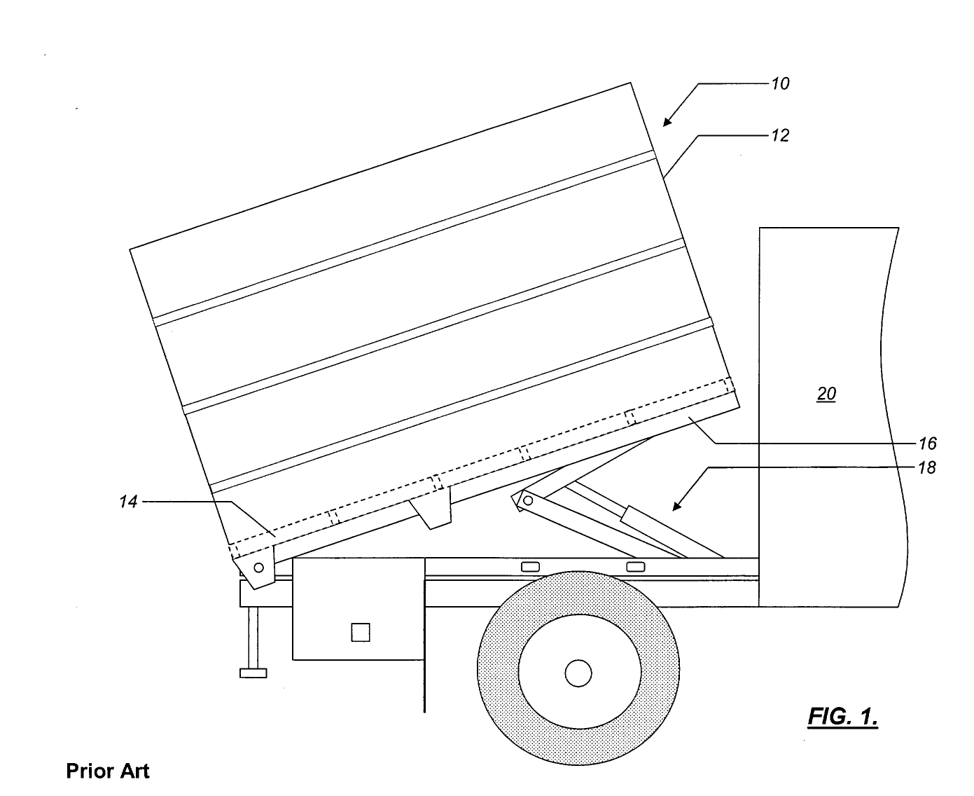

Referring to FIG. 1, a conventional box structure 10 for holding bulk material, such as wood chips and the like, typically includes a metal box 12 built on and partially disposed about a frame structure 14. This frame structure 14 is fixedly attached to a plurality of beams 16 which are configured to receive an attachment mechanism 18 for movably and/or removably attaching the box structure 10 to a vehicle 20, such as a truck or the like. The frame structure 14, and not the metal box 12, represents the core structural element of the system as a whole.

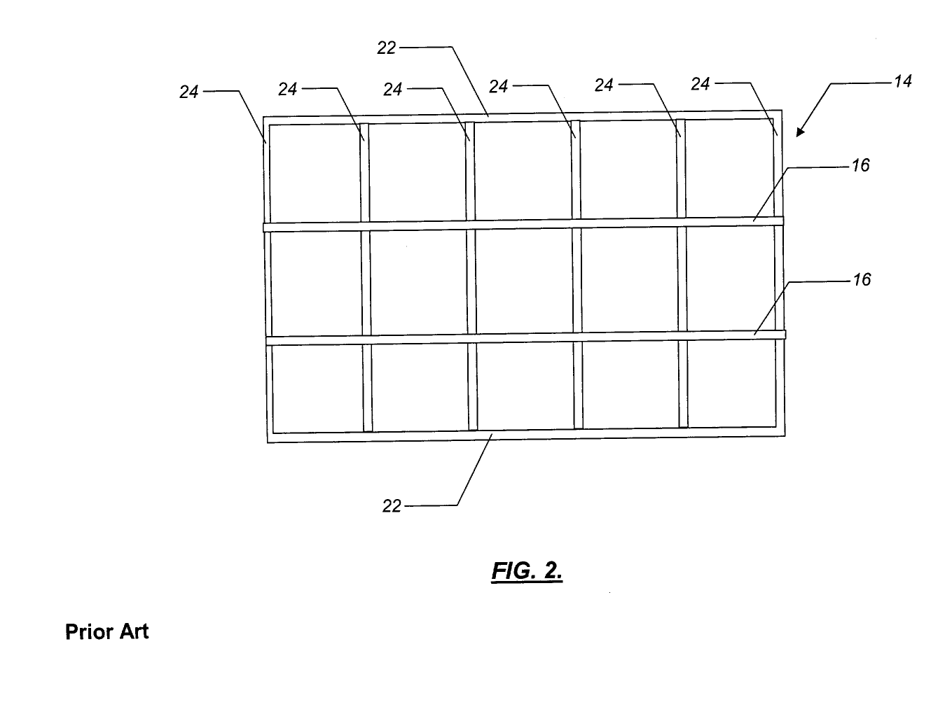

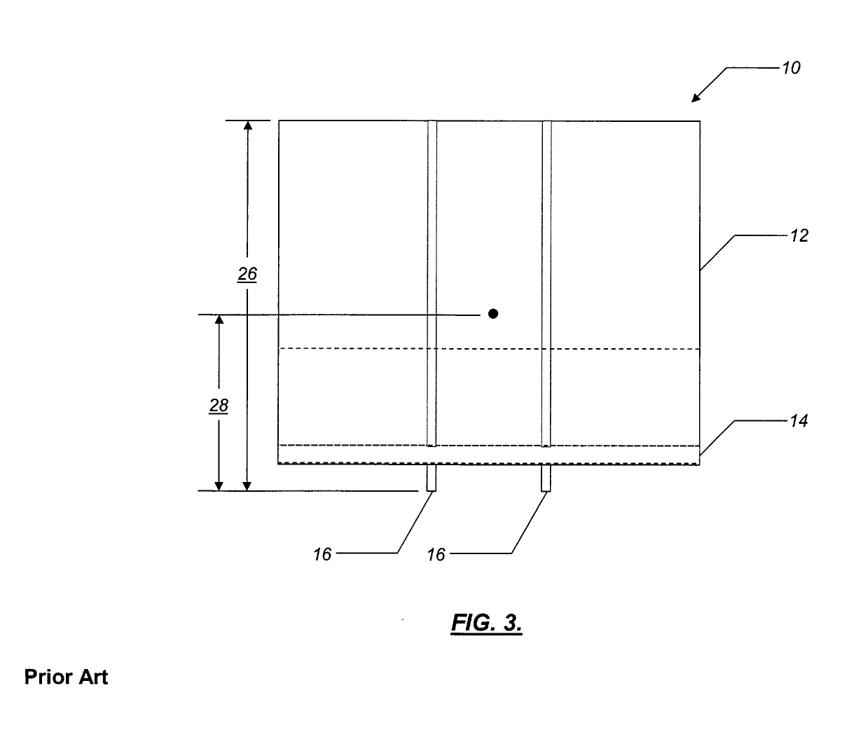

Referring to FIG. 2, the frame structure 14 typically consists of a plurality of horizontal members 22 and vertical members 24 that must be aligned and welded together. The presence of the frame structure 14 increases the overall height 26 (see FIG. 3) of the system, thus increasing the height 28 (see FIG. 3) of its center of gravity. For example, the frame structure 14 may increase the overall height 26 of the system by as much as 2 to 6 inches (typically about 4 inches).

The metal box 12, the frame structure 14 and the plurality of beams 16 are typically made of a mild steel that has a corrosion-resistant coating. For example, galvanneal steel is typically used. Galvanneal steel is produced on a continuous hot-dipped galvanized steel line. As the steel emerges from a molten zinc bath, excess zinc is removed from the surface of the steel using heated air knives. An annealing furnace is then used to convert the zinc into a corrosion-resistant zinc-iron alloy coating. In order to prepare the coating for finishing, the surface must be prepared with a solvent to remove foreign substances and contaminates. If the corrosion-resistant coating is scratched or otherwise damaged (or if it is defective), the steel underneath is exposed to the elements and subject to corrosion. Thus, galvanneal steel and the like may not be sandblasted and refinished.

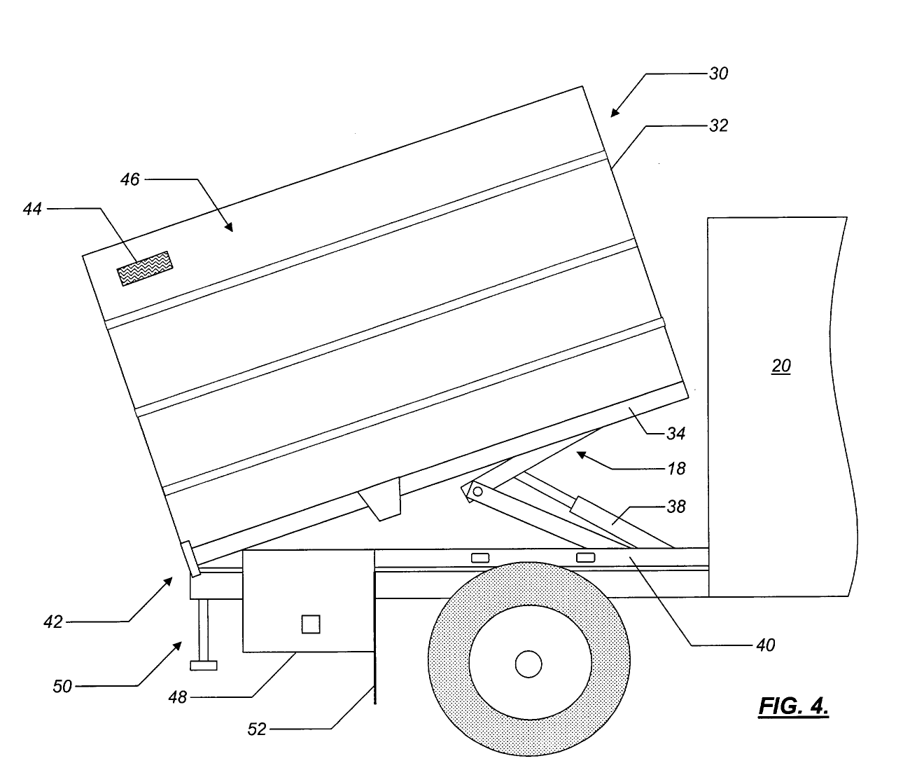

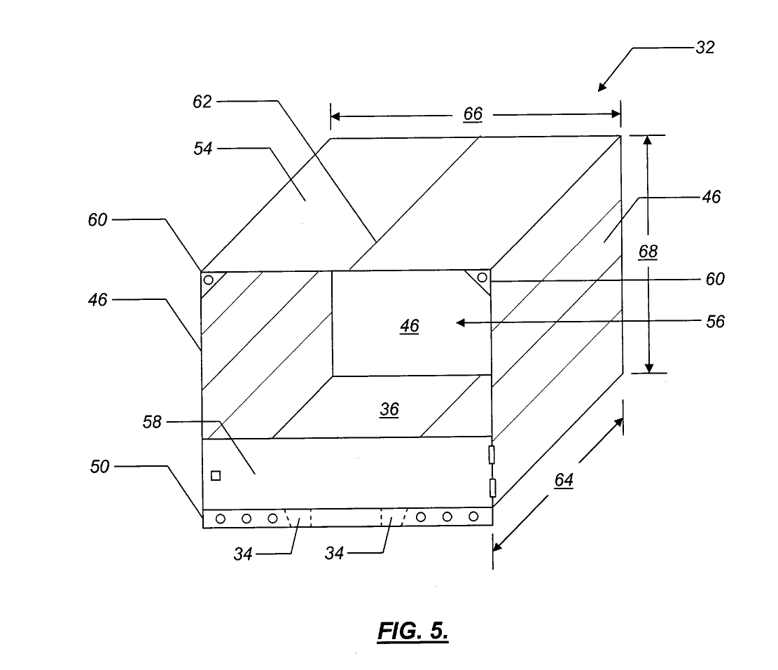

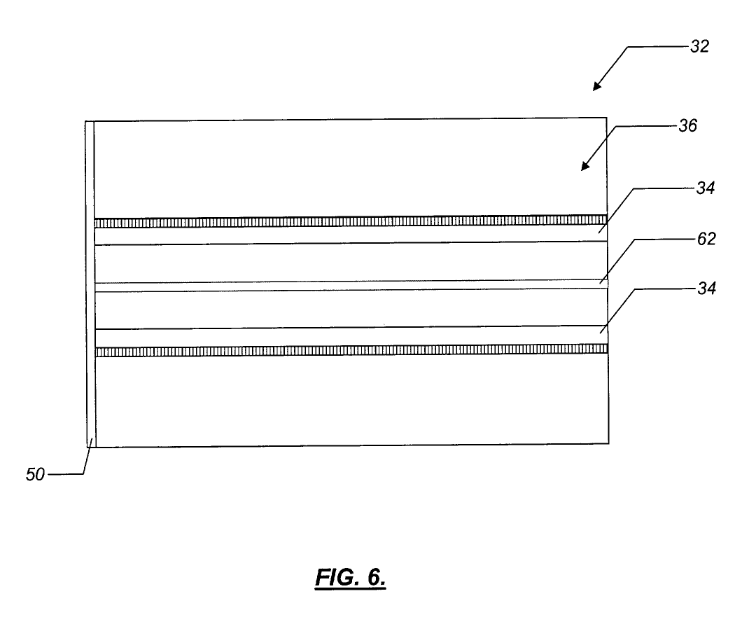

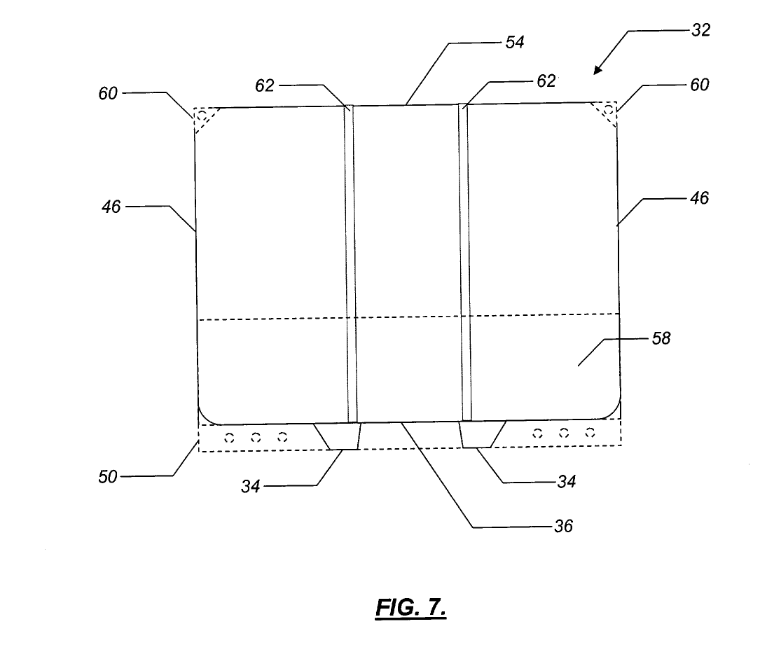

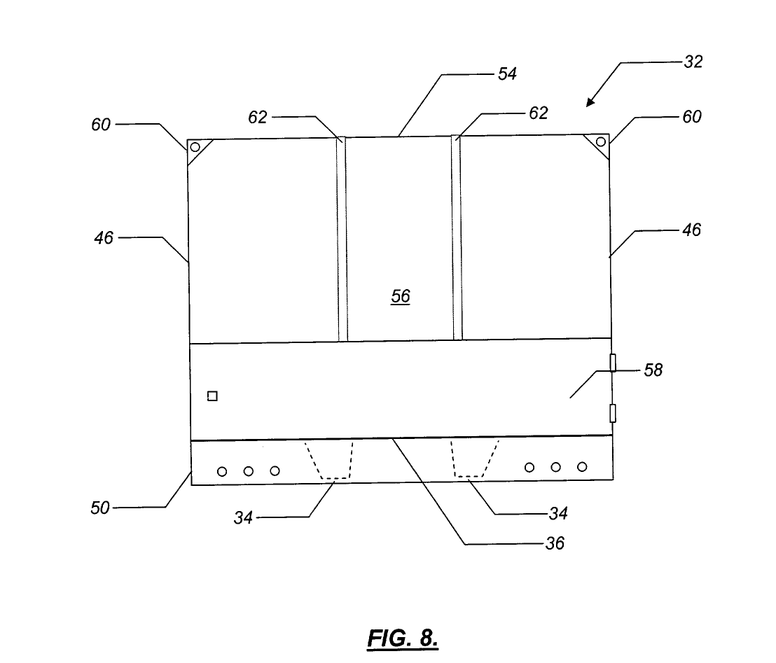

Referring to FIG. 4, in one embodiment of the present invention, the unibody box structure 30 includes a box member 32. The box member 32 may be made of a metal, such as steel (as described in greater detail herein below), or any other suitable substantially-rigid material. A plurality of channel structures 34 are disposed directly adjacent to and in direct contact with a bottom member 36 (see FIGS. 5, 6, 7 and 8) of the box member 32. Preferably, the plurality of channel structures 34 are fixedly attached to, such as by welding, or integrally formed with the bottom member 36 of the box member 32. The plurality of channel structures 34 are configured to receive an attachment mechanism 18 for movably and/or removably attaching the box structure 30 to a vehicle 20, such as a truck or the like. For example, the unibody box structure 30 of the present invention may be used in conjunction with a medium-duty truck or the like. The attachment mechanism 18 incorporates a hydraulic cylinder 38 or the like to actuate the attachment mechanism 18, thereby raising or lowering a portion of the box structure 30 and tilting it to unload bulk material, such as wood chips, recyclables and the like. Accordingly, a portion of the box structure 30 may be hinged to a frame 40 of the vehicle 20 via a hinge mechanism 42 or the like. Alternatively, the attachment mechanism 18 may simply hold the box structure 30 in place on the vehicle 20 and the box structure 30 may be selectively removed. Optionally, one or more vents 44 may be disposed within one or more of a plurality of side members 46 of the box member 32, allowing air to circulate through the box member 32. The vehicle 20 may also be equipped with appropriate tool boxes 48, fender assemblies 50 and mud guards 52, well known to those of ordinary skill in the art.

Referring to FIGS. 5, 7 and 8, the box member 32 includes the bottom member 36, the plurality of side members 46 and, optionally, a top member 54. The bottom member 36, the plurality of side members 46 and the top member 54 each have an inside surface, the plurality of inside surfaces collectively defining the interior of the box member 32, and an outside surface, the plurality of outside surfaces collectively defining the exterior of the box member 32. In one exemplary embodiment of the present invention, three (3) side members 46 are used and the back portion 56 of the box member 32 is open, allowing for the loading and unloading of bulk material. Optionally, a door structure 58 may be movably attached, i.e., hinged, to at least one of the plurality of side members 46 and partially cover the opening defined by the plurality of side members 46. Advantageously, the door structure 58 serves to selectively retain the bulk material disposed within the box member 32. The door structure 58 may include any suitable retaining or locking mechanisms. The box member 32 may also include a fender assembly 50 for covering the end portions of the plurality of channel structures 34. This fender assembly 50 may include a plurality of holes or the like for reducing its overall weight.

Preferably, the bottom member 36, the plurality of side members 46 and the top member 54 are fixedly attached to one another. Alternatively, the bottom member 36, the plurality of side members 46 and the top member 54 may be integrally formed from a substantially-rigid material (as described in greater detail herein below). For example, the appropriate edges of the bottom member 36, the plurality of side members 46 and the top member 54 may be bent into a tongue shape and welded together. A plurality of corner braces 60 may be used to increase the rigidity of the box member 32. The bottom member 36, the plurality of side members 46 and the top member 54 may also include one or more corrugations 62 formed along their length and/or width for increasing the rigidity of the box member 32.

The box member 32 has an overall length 64 of between about 10 and 16 feet, an overall width 66 of between about 6 and 9 feet (typically between about 7 and 8 feet) and an overall height 68 of between about 4 and 8 feet (typically between about 4 and 6 feet). It should be noted, however, that other suitable dimensions may be used.

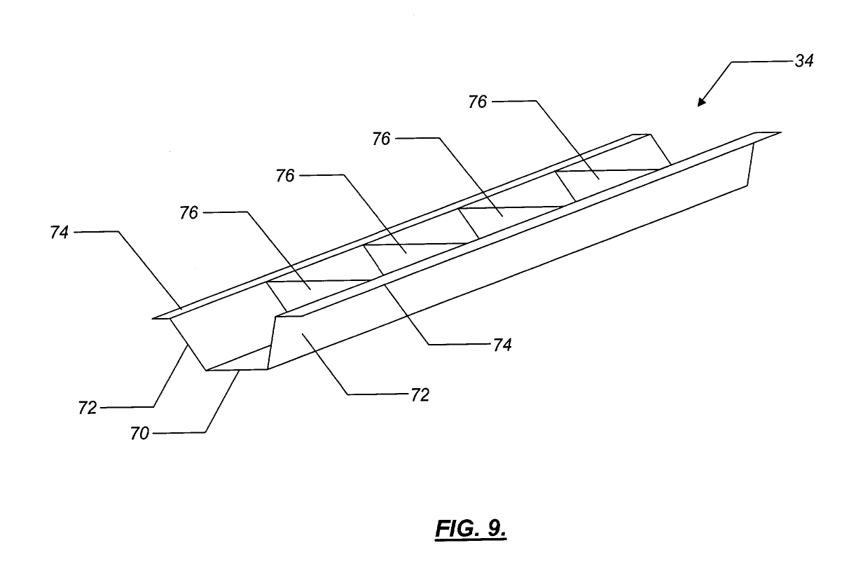

Referring to FIG. 9, each of the plurality of channel structures 34 includes a bottom member 70 and a plurality of side members 72. Each of the plurality of side members 72 terminate in a flange 74, suitable for welding to the bottom member 36 (FIGS. 5, 6, 7 and 8) of the box member 32 (FIGS. 4, 5, 6, 7 and 8). Preferably, the bottom member 70, the plurality of side members 72 and the plurality of flanges 74 are integrally formed from a substantially-rigid material (as described in greater detail herein below). The plurality of side members 72 may be bent outward at any suitable angle. A plurality of rib structures 76 may be disposed within the interior portion of each of the plurality of channel structures 34 to increase their rigidity. It will be readily apparent to those of ordinary skill in the art that other embodiments and examples of channel structures may be used to receive the attachment mechanism 18 (FIGS. 1 and 4) for movably and/or removably attaching the box structure 30 (FIG. 1) to the vehicle 20 (FIGS. 1 and 4).

Optionally, the components that make up the box member 32 (FIGS. 4, 5, 6, 7 and 8) and the plurality of channel structures 34 (FIGS. 4, 5, 6, 7, 8 and 9) are formed from a high-strength, corrosion-resistant material, such as a steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium. Examples of such a steel include COR-TEN A, COR-TEN B, COR-TEN B-QT and COR-TEN C (registered trademarks of USX Corporation), produced by the U.S. Steel Group. These steels are preferable because they have a relatively high strength, they are corrosion-resistant throughout and they are sufficiently formable. It should be noted, however, that any other high-strength, corrosion-resistant, formable materials may be used. For example, COR-TEN X or COR-TEN W (registered trademarks of USX Corporation), produced by the U.S. Steel Group, may be used for nuts, bolts and fasteners associated with the unibody box structure 30 (FIG. 4) of the present invention.

Optionally, the components that make up the box member 32 (FIGS. 4, 5, 6, 7 and 8) and the plurality of channel structures 34 (FIGS. 4, 5, 6, 7, 8 and 9) are also powder coated to enhance their functionality and aesthethic qualities. Where appropriate, this powder coating may include an abrasive material, providing an anti-slip coating in those areas.

Although the unibody box structure for holding bulk material of the present invention has been shown and described in conjunction with preferred embodiments and examples thereof, it will be readily apparent to those of ordinary skill in the art that other embodiments and examples may perform similar functions and/or achieve similar results. All such equivalent embodiments and examples are within the spirit and scope of the present invention and are intended to be covered by the following claims.

What is claimed is:

1. A box structure for holding bulk material, comprising:
a bottom member having an inside surface and an outside surface, wherein the bottom member is formed from a substantially-rigid material; and
a plurality of channel structures in direct contact with and fixedly attached to the outside surface of the bottom member, wherein each of the plurality of channel structures is formed from a substantially-rigid material.

2. The box structure of claim 1, wherein the bottom member and the plurality of channel structures are formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

3. The box structure of claim 1, further comprising a powder coating disposed on the inside surface and the outside surface of the bottom member.

4. The box structure of claim 3, wherein the powder coating disposed on the inside surface of the bottom member further comprises an abrasive material.

5. The box structure of claim 1, wherein each of the plurality of channel structures is welded to the outside surface of the bottom member.

6. The box structure of claim 1, wherein each of the plurality of channel structures has an interior portion and an exterior portion.

7. The box structure of claim 6, further comprising a plurality of rib structures disposed within the interior portion of each of the plurality of channel structures.

8. The box structure of claim 1, wherein the plurality of channel structures are configured to receive an attachment mechanism for movably and/or removably attaching the box structure to a vehicle.

9. The box structure of claim 1, further comprising a plurality of side members each having an inside surface and an outside surface, the plurality of side members collectively defining an opening, wherein each of the plurality of side members is formed from a substantially-rigid material.

10. The box structure of claim 9, wherein each of the plurality of side members is formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

11. The box structure of claim 9, further comprising a powder coating disposed on the inside surface and the outside surface of each of the plurality of side members.

12. The box structure of claim 9, further comprising a door structure movably attached to at least one of the plurality of side members, the door structure for selectively covering a portion of the opening defined by the plurality of side members.

13. The box structure of claim 1, further comprising a top member having an inside surface and an outside surface, wherein the top member is formed from a substantially-rigid material.

14. The box structure of claim 13, wherein the top member is formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

15. The box structure of claim 13, further comprising a powder coating disposed on the inside surface and the outside surface of the top member.

16. The box structure of claim 1, wherein the bottom member and the plurality of channel structures are integrally formed.

17. A box structure for holding bulk material, comprising:
a bottom member having an inside surface and an outside surface, wherein the bottom member is formed from a substantially-rigid material;
a plurality of channel structures in direct contact with and fixedly attached to the outside surface of the bottom member, wherein each of the plurality of channel structures is formed from a substantially-rigid material, and wherein the plurality of channel structures are configured to receive an attachment mechanism for movably and/or removably attaching the box structure to a vehicle;
a plurality of side members each having an inside surface and an outside surface, the plurality of side members collectively defining an opening, wherein each of the plurality of side members is formed from a substantially-rigid material; and
a top member having an inside surface and an outside surface, wherein the top member is formed from a substantially-rigid material.

18. The box structure of claim 17, wherein the bottom member, the plurality of channel structures, the plurality of side members and the top member are formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

19. The box structure of claim 17, further comprising a powder coating disposed on the inside surfaces and the outside surfaces of the bottom member, the plurality of side members and the top member.

20. The box structure of claim 19, wherein the powder coating disposed on the inside surface of the bottom member further comprises an abrasive material.

21. The box structure of claim 17, wherein each of the plurality of channel structures is welded to the outside surface of the bottom member.

22. The box structure of claim 17, wherein each of the plurality of channel structures has an interior portion and an exterior portion.

23. The box structure of claim 22, further comprising a plurality of rib structures disposed within the interior portion of each of the plurality of channel structures.

24. The box structure of claim 17, further comprising a door structure movably attached to at least one of the plurality of side members, the door structure for selectively covering a portion of the opening defined by the plurality of side members.

25. A method for manufacturing a box structure for holding bulk material, comprising:
providing a bottom member having an inside surface and an outside surface, wherein the bottom member is formed from a substantially-rigid material;
placing a plurality of channel structures in direct contact with and fixedly attaching the plurality of channel structures to the outside surface of the bottom member, wherein each of the plurality of channel structures is formed from a substantially-rigid material, and wherein the plurality of channel structures are configured to receive an attachment mechanism for movably and/or removably attaching the box structure to a vehicle;
providing a plurality of side members each having an inside surface and an outside surface, the plurality of side members collectively defining an opening, wherein each of the plurality of side members is formed from a substantially-rigid material; and
providing a top member having an inside surface and an outside surface, wherein the top member is formed from a substantially-rigid material.

26. The method of claim 25, wherein the bottom member, the plurality of channel structures, the plurality of side members and the top member are formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

27. The method of claim 25, further comprising disposing a powder coating on the inside surfaces and the outside surfaces of the bottom member, the plurality of side members and the top member.

28. The method of claim 27, wherein the powder coating disposed on the inside surface of the bottom member further comprises an abrasive material.

29. The method of claim 25, further comprising welding each of the plurality of channel structures to the outside surface of the bottom member.

30. The method of claim 25, wherein each of the plurality of channel structures has an interior portion and an exterior portion.

31. The method of claim 30, further comprising disposing a plurality of rib structures within the interior portion of each of the plurality of channel structures.

32. The method of claim 25, further comprising movably attaching a door structure to at least one of the plurality of side members, the door structure for selectively covering a portion of the opening defined by the plurality of side members.

33. A box structure for holding bulk material, comprising:
a bottom member having an inside surface and an outside surface, wherein the bottom member is formed from a high-strength, corrosion-resistant material; and
a plurality of side members each having an inside surface and an outside surface, the plurality of side members collectively defining an opening, wherein each of the plurality of side members is formed from a high-strength, corrosion-resistant material.

34. The box structure of claim 33, further comprising a top member having an inside surface and an outside surface, wherein the top member is formed from a high-strength, corrosion-resistant material.

35. The box structure of claim 34, wherein the bottom member, the plurality of side members and the top member are formed from a high-strength, corrosion-resistant steel comprising no more than about 0.19% carbon, between about 0.20 and 1.35% manganese, no more than about 0.15% phosphorous, no more than about 0.05% sulfur, between about 0.25 to 0.75% silicon, between about 0.25 and 0.55% copper, between about 0.40 and 1.25% chromium, no more than about 0.65% nickel and no more than about 0.10% vanadium.

36. A box structure for holding bulk material, comprising:
a bottom member having an inside surface and an outside surface, wherein the bottom member is formed from a substantially-rigid material;
a plurality of side members each having an inside surface and an outside surface, the plurality of side members collectively defining an opening, wherein each of the plurality of side members is formed from a substantially-rigid material; and
a powder coating disposed on the inside surfaces and the outside surfaces of the bottom member and the plurality of side members.

37. The box structure of claim 36, further comprising a top member having an inside surface and an outside surface, wherein the top member is formed from a substantially-rigid material.

38. The box structure of claim 37, further comprising a powder coating disposed on the inside surface and the outside surface of the top member.

39. The box structure of claim 36, wherein at least a portion of the powder coating disposed on the inside surface of the bottom member further comprises an abrasive material.
